(19) United States
(12) Patent Application Publication
(10) Pub. No.: US 2026/0055909 A1
(43) Pub. Date: Feb. 26, 2026

(54) METHOD FOR DETECTING WATER SHORTAGE OF HUMIDIFIER

(71) Applicant: Guangzhou Issyzone Technology Co., Limited, Guangzhou (CN)

(72) Inventors: Taiping Yang, Guangzhou (CN); Zegang Ye, Guangzhou (CN); Shuneng Huang, Guangzhou (CN)

(21) Appl. No.: 18/908,806

(22) Filed: Oct. 8, 2024

(30) Foreign Application Priority Data
Aug. 23, 2024 (CN) 2024111667192

(51) Int. Cl. F24F 11/30; F24F 6/00; F24F 6/12; F24F 140/00

(52) U.S. Cl. CPC F24F 11/30; F24F 6/12; F24F 2006/008; F24F 2140/00

(57) ABSTRACT

The present invention discloses a method for detecting water shortage of a humidifier, including the following steps: obtaining a real-time feedback voltage output by a target atomization plate within a preset time range, extracting a target voltage from the real-time feedback voltage, detecting, by using a reference feedback voltage as a reference value, whether there is power offset of the target voltage, and if there is the power offset, triggering second power compensation of the target atomization plate, and running a water shortage detection program simultaneously, where the water shortage detection program includes: extracting a to-be-detected time domain signal from the real-time feedback voltage and searching for a characteristic value from the to-be-detected time domain signal. Benefits of the present invention are as follows: The water shortage of the humidifier is detected without using a sensor, and reliability of the humidifier is improved.

### CROSS REFERENCE TO RELATED APPLICATIONS

The present application claims the priority of Chinese patent application No. 2024111667192, filed on Aug. 23, 2024, and contents of which are incorporated herein by reference.

### TECHNICAL FIELD

The present invention relates to the technical field of humidifiers, and in particular, to a method for detecting water shortage of a humidifier.

### TECHNICAL BACKGROUND

Currently, a mainstream method for detecting water shortage of a humidifier is mainly to arrange a magnetic floating member in a water tank, to power on or off an atomization plate through the magnetic floating member and a reed switch. However, the magnetic floating member has a disadvantage of a complex structure, and during long-term use, water scale is likely to deposit on a surface of the magnetic floating member, and microorganisms are also likely to grow on the surface of the magnetic floating member, resulting in increased friction on the surface of the magnetic floating member and even jam eventually. In addition, the reed switch is a device made of glass and is likely to be damaged, and therefore, the humidifier is prone to misjudgment of a water level after being used for a long time, thereby decreasing reliability of such product.

### SUMMARY

In view of the foregoing problems, the present invention proposes a method for detecting water shortage of a humidifier, intended to resolve a problem of detecting the water shortage of the humidifier without using a magnetic floating switch.

To resolve the foregoing technical problem, a first aspect of the present invention proposes a method for detecting water shortage of a humidifier, including the following steps:
performing frequency sweeping on a target atomization plate, to obtain optimal working frequency;
driving the target atomization plate at the optimal working frequency to obtain a real-time feedback voltage of the target atomization plate, and after comparison between the real-time feedback voltage and a pre-stored voltage, performing first power compensation on the target atomization plate to obtain a reference feedback voltage;
obtaining a real-time feedback voltage output by the target atomization plate within a preset time range, extracting a target voltage from the real-time feedback voltage, detecting, by using the reference feedback voltage as a reference value, whether there is power offset of the target voltage, and if there is the power offset, triggering second power compensation of the target atomization plate, and running a water shortage detection program simultaneously, where
the water shortage detection program includes: extracting a to-be-detected time domain signal from the real-time feedback voltage and searching for a characteristic value from the to-be-detected time domain signal, where the characteristic value consists of a rising edge and a falling edge and exists in a discrete voltage on a downward trend as a whole; and
when the characteristic value is detected, stopping voltage input of the target atomization plate.

In some embodiments, the first power compensation includes:
after the target atomization plate is started initially, performing comparison to obtain a difference between the real-time feedback voltage and the pre-stored voltage, and performing PWM power compensation on the target atomization plate based on the difference.

In some embodiments, an extraction process of the target voltage includes: selecting all peak voltages from real-time feedback voltages, calculating an average of all the peak voltages, and defining the average as the target voltage.

In some embodiments, the second power compensation includes:
on the premise that the target atomization plate is not started initially, performing comparison to obtain a difference between the target voltage and the reference feedback voltage, and performing PWM power compensation on the target atomization plate based on the difference.

In some embodiments, if there is no power offset of the target voltage, the second power compensation is skipped, and the water shortage detection program is run immediately.

In some embodiments, if the characteristic value is not detected via the water shortage detection program, the real-time feedback voltage is obtained again, it is re-detected whether there is the power offset of the target voltage, it is determined, based on a status of the power offset, whether to perform the second power compensation on the target atomization plate, and the next round of the water shortage detection program is run simultaneously until the characteristic value is detected.

In some embodiments, an obtaining process of the to-be-detected time domain signal includes: selecting all peak voltages from real-time feedback voltages, then performing smoothing processing on the peak voltages to obtain a curve of processed discrete voltages, and defining the processed discrete voltage as the to-be-detected time domain signal.

A second aspect of the present invention proposes an apparatus for detecting water shortage of a humidifier, including:
a sweeping module, configured to perform frequency sweeping on a target atomization plate, to obtain optimal working frequency;
a first voltage compensation module, configured to: drive the target atomization plate at the optimal working frequency to obtain a real-time feedback voltage of the target atomization plate, and after comparison between the real-time feedback voltage and a pre-stored voltage, perform first power compensation on the target atomization plate to obtain a reference feedback voltage;
a second voltage compensation module, configured to: obtain a real-time feedback voltage output by the target atomization plate within a preset time range, extract a target voltage from the real-time feedback voltage, detect, by using the reference feedback voltage as a reference value, whether there is power offset of the target voltage, and if there is the power offset, trigger second power compensation of the target atomization plate, and run a water shortage detection program simultaneously;
a water shortage detection module, configured to: extract a to-be-detected time domain signal from the real-time feedback voltage and search for a characteristic value from the to-be-detected time domain signal, where the characteristic value consists of a rising edge and a falling edge and exists in a discrete voltage on a downward trend as a whole; and
a power-off module, configured to: when the characteristic value is detected, stop voltage input of the target atomization plate.

A third aspect of the present invention proposes an apparatus for detecting water shortage of a humidifier, where the apparatus includes a memory, a processor, and a communication module, where
the memory is configured to store executable program code;
the processor is coupled with the memory; and
the processor invokes the executable program code stored in the memory to perform the foregoing method for detecting water shortage of a humidifier.

A fourth aspect of the present invention proposes a computer-readable storage medium, where the computer-readable storage medium stores a computer instruction, and when being invoked, the computer instruction is used to perform the foregoing method for detecting water shortage of a humidifier.

Benefits of the present invention are as follows: The real-time feedback voltage output by the target atomization plate is obtained, and the characteristic value in the real-time feedback voltage is used as a basis for determining water shortage, to detect the water shortage of the humidifier without using the sensor, thereby improving the reliability of the humidifier.

### BRIEF DESCRIPTION OF THE DRAWINGS

FIG. 1 is a schematic flowchart of a method for detecting water shortage of a humidifier disclosed in Embodiment 1 of the present invention;

FIG. 2 is a diagram of a circuit principle of a circuit for detecting water shortage of a humidifier disclosed in Embodiment 1 of the present invention;

FIG. 3 is a schematic diagram of a real-time feedback voltage disclosed in Embodiment 1 of the present invention;

FIG. 4 is a schematic diagram of a characteristic value disclosed in Embodiment 1 of the present invention; and

FIG. 5 is a schematic flowchart of a method for detecting water shortage of a humidifier disclosed in Embodiment 3 of the present invention.

### DETAILED DESCRIPTION OF EMBODIMENTS

To make the purpose, the technical solution and the advantage of the present invention clearer and more explicit, content of the present invention is further described in detail below with reference to the accompanying drawings and embodiments. It should be understood that, the embodiments described here are only intended to explain the present invention rather than limit the present invention. In addition, it should also be noted that, for ease of description, only some contents related to the present invention other than all the contents are shown in the drawings.

### Embodiment 1

This embodiment proposes a method for detecting water shortage of a humidifier, where a real-time feedback voltage output by a target atomization plate is obtained, and a characteristic value in the real-time feedback voltage is used as a basis for determining the water shortage, to detect the water shortage of the humidifier without using a sensor, thereby improving reliability of the humidifier.

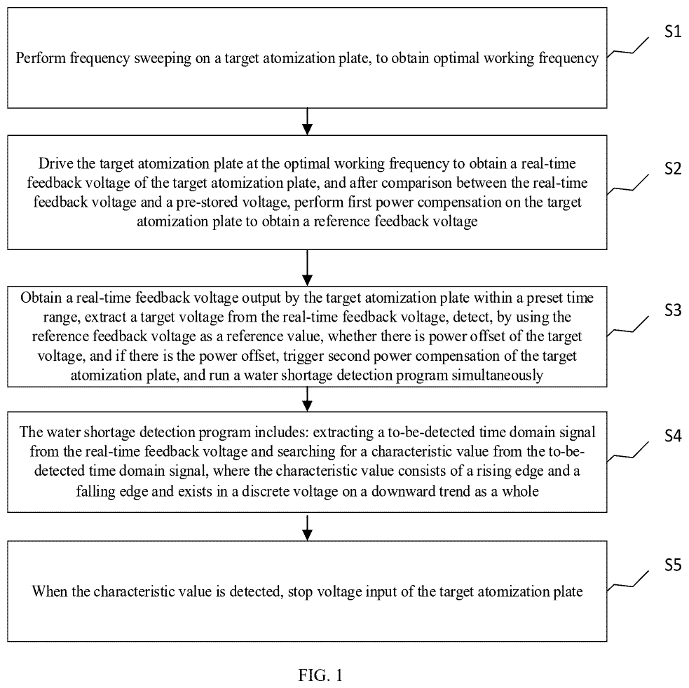

As shown in FIG. 1, the method includes the following steps:

S1. Perform frequency sweeping on a target atomization plate, to obtain optimal working frequency.

In consideration that there is a slight difference between actual parameters of atomization plates with the same specification, in this solution, before the feedback voltage is obtained, a frequency sweeping operation is performed on the target atomization plate to obtain corresponding optimal working frequency.

S2. Drive the target atomization plate at the optimal working frequency to obtain a real-time feedback voltage of the target atomization plate, and after comparison between the real-time feedback voltage and a pre-stored voltage, perform first power compensation on the target atomization plate to obtain a reference feedback voltage.

Under impact of factors such as a battery voltage, a voltage applied to two ends of the target atomization plate is unstable, and therefore, in this embodiment, the target atomization plate first needs to be compensated, so that a volume of spray of the humidifier is kept constant. Input power of the atomization plate is usually compensated for in a feedback adjustment manner. In an example, the first power compensation includes:
after the target atomization plate is started initially, performing comparison to obtain a difference between the real-time feedback voltage and the pre-stored voltage, and performing PWM power compensation on the target atomization plate based on the difference.

The pre-stored voltage in this embodiment is an average obtained by batch experiments of the atomization plates with the same specification, and may be slightly deviated from an actual reference voltage, and therefore, a compared voltage in the first compensation is the pre-stored voltage with a main function of eliminating an individual difference between the atomization plates, and the reference feedback voltage is subsequently calculated.

S3. Obtain a real-time feedback voltage output by the target atomization plate within a preset time range, extract a target voltage from the real-time feedback voltage, detect, by using the reference feedback voltage as a reference value, whether there is power offset of the target voltage, and if there is the power offset, trigger second power compensation of the target atomization plate, and run a water shortage detection program simultaneously.

As one of important inventive points of this solution, an extraction process of the target voltage includes: selecting all peak voltages from real-time feedback voltages, calculating an average of all the peak voltages, and defining the average as the target voltage. Due to a large difference between a peak and a trough of the real-time feedback voltage, it is likely to cause offset in the compensation process if the average is calculated directly, and therefore, a smooth target voltage can be obtained by selecting the peaks first and then averaging the peaks, which facilitates detection of the characteristic value in step S4.

In an example, the second power compensation includes:
on the premise that the target atomization plate is not started initially, performing comparison to obtain a difference between the target voltage and the reference feedback voltage, and performing PWM power compensation on the target atomization plate based on the difference.

In step S3, if there is the power offset of the target voltage, it means that moisture in an atomization cotton swab and/or a voltage (with a battery as a power supply) across two ends of the atomization plate is changing, and therefore, it is necessary to compensate the target atomization plate first, and a water shortage detection procedure is carried out simultaneously to determine whether the atomization plate is being heated due to water shortage. A difference from the first power compensation is that a reference used for the second power compensation is the reference feedback voltage, and during operation of the humidifier, the real-time feedback voltage is cyclically detected, and the second power compensation is performed on the target atomization plate. The second power compensation herein is only used for differentiation from the first power compensation, and actually, the second power compensation is performed multiple times until the humidifier is shut down due to water shortage.

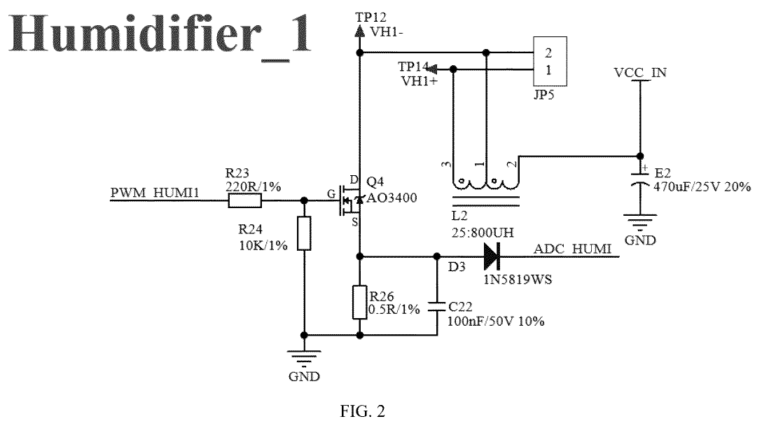

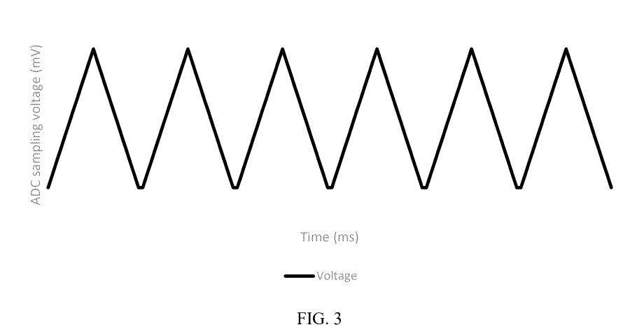

Irrespective of the first power compensation or the second power compensation, from the perspective of circuit control, the real-time feedback voltage output by the target atomization plate can be detected in parallel. As shown in FIG. 2, when a PWM wave is input into a grid (PWM_HUMI1) of a mos tube, a corresponding sawtooth-like wave is obtained at an ADC_HUMI end. The greater the duty cycle of the PWM, the higher the peak of the obtained sawtooth-like wave. The higher the average voltage, the greater the volume of atomization, and vice versa. A voltage of the sawtooth-like wave is compared with the reference voltage to control the duty cycle of the PWM, to implement a relatively stable closed-loop control. Through data of multiple experiments, ADC feedback of the target atomization plate at resonant frequency is obtained as an AC sawtooth-like wave shown in FIG. 3, and in this solution, a peak voltage of the real-time feedback voltage is used as the reference voltage for PWM power adjustment and is used to calculate the reference feedback voltage.

In another optional solution example, if there is no power offset of the target voltage, the second power compensation is skipped, and the water shortage detection program is run immediately. Because the characteristic value only appears once for a very short time, in this solution, regardless of whether there is power offset, it is necessary to detect water shortage in this round of detection program to avoid missing the characteristic value. For a specific principle, refer to step S4 below.

S4. The water shortage detection program includes: extracting a to-be-detected time domain signal from the real-time feedback voltage and searching for a characteristic value from the to-be-detected time domain signal, where the characteristic value consists of a rising edge and a falling edge and exists in a discrete voltage on a downward trend as a whole.

In a preferred solution, an obtaining process of the to-be-detected time domain signal includes: selecting all peak voltages from real-time feedback voltages, then performing smoothing processing on the peak voltages to obtain a curve of processed discrete voltages, and defining the processed discrete voltage as the to-be-detected time domain signal. In the above processing method, detection accuracy of the to-be-detected time domain signal is improved.

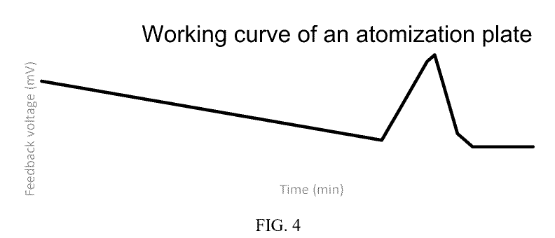

As the humidifier works, moisture in an absorbent cotton swab is continuously dispersed by the atomization plate and blown into an external environment by a fan, a volume of water in a container in this process continues to decrease, and water in contact with the absorbent cotton swab also continues to decrease. In a case without water shortage, the voltage is constantly around the reference feedback voltage after power compensation. Therefore, as time goes on, the volume of water and the voltage in the humidifier gradually decreases, power consumption of the humidifier tends to decrease, and as a result, the to-be-detected time domain signal also tends to decrease, which is embodied as decrease in the feedback voltage, as shown in FIG. 4. Eventually, when the moisture is reduced below a threshold, the absorbent cotton swab cannot absorb new moisture from the container, the moisture contained in the absorbent cotton swab is rapidly consumed, and according to a measurement result, the feedback voltage increases temporarily after the power compensation, and then decreases rapidly, to form a characteristic value containing a rising edge and a falling edge. A reason is that when there is still water in the absorbent cotton swab, the feedback voltage of the atomization plate is low, and when the absorbent cotton swab is heated without moisture, the feedback voltage of the atomization plate is also low, but in a critical state from wetness to dryness, due to the water shortage, the voltage continues to rise, and when a heating state without moisture starts after the water is depleted, the voltage decreases rapidly, which forms a process of first rising and then decreasing, indicating that the target atomization plate is heated without moisture.

S5. When the characteristic value is detected, stop voltage input of the target atomization plate.

In this embodiment, a power-off apparatus of the target atomization plate can stop the input voltage across the two ends of the target atomization plate by using the MOS tube, but also can implement on-off functions through elements such as a relay. Details are not enumerated herein.

In another example, if the characteristic value is not detected via the water shortage detection program, step S3 is performed again to obtain the real-time feedback voltage again, re-detect whether there is the power offset of the target voltage, and determine, based on a status of the power offset, whether to perform the second power compensation on the target atomization plate, and the next round of the water shortage detection program (S4) is further run simultaneously until the characteristic value is detected.

If no characteristic value is detected during the water shortage detection procedure, this proves that the moisture in the absorbent cotton swab is not depleted, and therefore, it is necessary to obtain the newest feedback signal and re-detect the characteristic value until the moisture in the absorbent cotton swab is depleted and the voltage input of the target atomization plate is stopped.

Obviously, in this embodiment, a method of detecting the characteristic value contained in the real-time feedback voltage (the to-be-detected time domain signal) can replace a method of detecting a heating case without moisture through the sensor, which improves reliability of the apparatus.

### Embodiment 2

This embodiment proposes an apparatus for detecting water shortage of a humidifier, including:
a sweeping module, configured to perform frequency sweeping on a target atomization plate, to obtain optimal working frequency;
a first voltage compensation module, configured to: drive the target atomization plate at the optimal working frequency to obtain a real-time feedback voltage of the target atomization plate, and after comparison between the real-time feedback voltage and a pre-stored voltage, perform first power compensation on the target atomization plate to obtain a reference feedback voltage;
a second voltage compensation module, configured to: obtain a real-time feedback voltage output by the target atomization plate within a preset time range, extract a target voltage from the real-time feedback voltage, detect, by using the reference feedback voltage as a reference value, whether there is power offset of the target voltage, and if there is the power offset, trigger second power compensation of the target atomization plate, and run a water shortage detection program simultaneously;
a water shortage detection module, configured to: extract a to-be-detected time domain signal from the real-time feedback voltage and search for a characteristic value from the to-be-detected time domain signal, where the characteristic value consists of a rising edge and a falling edge and exists in a discrete voltage on a downward trend as a whole; and a power-off module, configured to: when the characteristic value is detected, stop voltage input of the target atomization plate.

For functions of the modules in this embodiment, refer to steps S1 to S5 in Embodiment 1.

### Embodiment 3

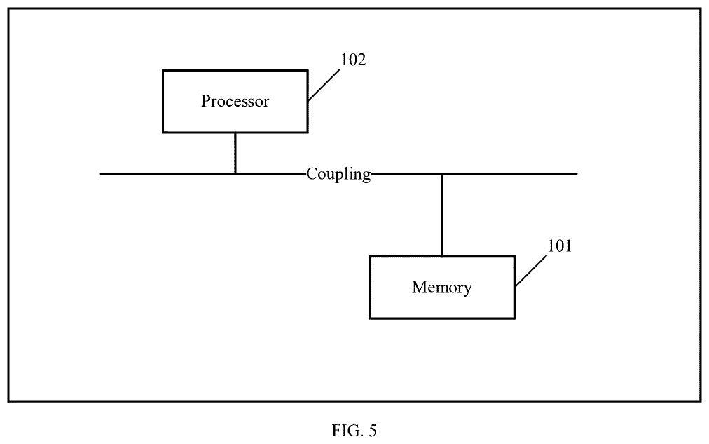

Referring to FIG. 5, FIG. 5 is a schematic structural diagram of another apparatus for detecting water shortage of a humidifier disclosed in an embodiment of the present invention. As shown in FIG. 5, a control platform may include:
a memory 101, configured to store executable program code; and
a processor 102, coupled with the memory 101, where
the processor 102 invokes the executable program code stored in the memory 101, to perform steps in the method for detecting water shortage of a humidifier described in Embodiment 1.

### Embodiment 4

This embodiment of the present invention discloses a computer program product, where the computer program product includes a non-transitory computer-readable storage medium storing a computer program, and the computer program can be run to enable a computer to perform steps in the method for detecting water shortage of a humidifier described in Embodiment 1.

The foregoing apparatus embodiments are only exemplary, the modules described as discrete components may or may not be physically separated, and components shown as modules may or may not be physical modules, that is, the components may be located at one area, or may also be distributed on multiple network modules. Some or all of the modules may be selected based on actual requirements to achieve the objectives of the solutions of the embodiments. Persons of ordinary skills in the art can understand and implement the solutions without creative efforts.

Through specific description of the foregoing embodiments, persons skilled in the art can clearly understand that the embodiments can be implemented via software in combination with a necessary general-purpose hardware platform, or via hardware. Based on such understanding, essence or parts of the foregoing technical solutions that contribute to the prior art may be embodied in a form of a software product. The computer software product may be stored in a computer-readable storage medium, and the storage medium includes Read-Only Memory (ROM), Random Access Memory (RAM), Programmable Read-only Memory (PROM), Erasable Programmable Read-Only Memory (EPROM), One-time Programmable Read-Only Memory (OTPROM), Electrically-Erasable Programmable Read-Only Memory (EEPROM), Compact Disc Read-Only Memory (CD-ROM) or another optical disc memory, a magnetic disk memory, a cassette memory, or any other computer-readable medium that can be used to carry or store data.

Finally, it should be noted that, disclosed embodiments of the method for detecting water shortage of a humidifier disclosed in the embodiments of the present invention are only preferred embodiments of the present invention, and are only intended to describe other than limit the technical solutions of the present invention. Although the present invention is described in detail with reference to the foregoing embodiments, persons of ordinary skills in the art should understand that they may still make modifications to the technical solutions described in the foregoing embodiments or make equivalent replacements to some technical features therein. Despite these modifications and replacements, the essence of the corresponding technical solutions shall not depart from the spirit and scope of the technical solutions of the embodiments of the solutions.

The present invention discloses a method for detecting water shortage of a humidifier, including the following steps: obtaining a real-time feedback voltage output by a target atomization plate within a preset time range, extracting a target voltage from the real-time feedback voltage, detecting, by using a reference feedback voltage as a reference value, whether there is power offset of the target voltage, and if there is the power offset, triggering second power compensation of the target atomization plate, and running a water shortage detection program simultaneously, where the water shortage detection program includes: extracting a to-be-detected time domain signal from the real-time feedback voltage and searching for a characteristic value from the to-be-detected time domain signal, where the characteristic value consists of a rising edge and a falling edge and exists in a discrete voltage on a downward trend as a whole; and when the characteristic value is detected, stopping voltage input of the target atomization plate. Benefits of the present invention are as follows: The water shortage of the humidifier is detected without using a sensor, and reliability of the humidifier is improved.

1. A method for detecting water shortage of a humidifier, comprising the following steps:
performing frequency sweeping on a target atomization plate, to obtain optimal working frequency;
driving the target atomization plate at the optimal working frequency to obtain a real-time feedback voltage of the target atomization plate, and after comparison between the real-time feedback voltage and a pre-stored voltage, performing first power compensation on the target atomization plate to obtain a reference feedback voltage;
obtaining a real-time feedback voltage output by the target atomization plate within a preset time range, extracting a target voltage from the real-time feedback voltage, detecting, by using the reference feedback voltage as a reference value, whether there is power offset of the target voltage, and if there is the power offset, triggering second power compensation of the target atomization plate, and running a water shortage detection program simultaneously, wherein
the water shortage detection program comprises: extracting a to-be-detected time domain signal from the real-time feedback voltage and searching for a characteristic value from the to-be-detected time domain signal, wherein the characteristic value consists of a rising edge and a falling edge and exists in a discrete voltage on a downward trend as a whole; and
when the characteristic value is detected, stopping voltage input of the target atomization plate.

2. The method for detecting water shortage of a humidifier according to claim 1, wherein the first power compensation comprises:
after the target atomization plate is started initially, performing comparison to obtain a difference between the real-time feedback voltage and the pre-stored voltage, and performing PWM power compensation on the target atomization plate based on the difference.

3. The method for detecting water shortage of a humidifier according to claim 1, wherein an extraction process of the target voltage comprises: selecting all peak voltages from real-time feedback voltages, calculating an average of all the peak voltages, and defining the average as the target voltage.

4. The method for detecting water shortage of a humidifier according to claim 1, wherein the second power compensation comprises:
on the premise that the target atomization plate is not started initially, performing comparison to obtain a difference between the target voltage and the reference feedback voltage, and performing PWM power compensation on the target atomization plate based on the difference.

5. The method for detecting water shortage of a humidifier according to claim 1, wherein if there is no power offset of the target voltage, the second power compensation is skipped, and the water shortage detection program is run immediately.

6. The method for detecting water shortage of a humidifier according to claim 1, wherein if the characteristic value is not detected via the water shortage detection program, the real-time feedback voltage is obtained again, it is re-detected whether there is the power offset of the target voltage, it is determined, based on a status of the power offset, whether to perform the second power compensation on the target atomization plate, and the next round of the water shortage detection program is run simultaneously until the characteristic value is detected.

7. The method for detecting water shortage of a humidifier according to claim 1, wherein an obtaining process of the to-be-detected time domain signal comprises: selecting all peak voltages from real-time feedback voltages, then performing smoothing processing on the peak voltages to obtain a curve of processed discrete voltages, and defining the processed discrete voltage as the to-be-detected time domain signal.

8. An apparatus for detecting water shortage of a humidifier, comprising:
a sweeping module, configured to perform frequency sweeping on a target atomization plate, to obtain optimal working frequency;
a first voltage compensation module, configured to: drive the target atomization plate at the optimal working frequency to obtain a real-time feedback voltage of the target atomization plate, and after comparison between the real-time feedback voltage and a pre-stored voltage, perform first power compensation on the target atomization plate to obtain a reference feedback voltage;
a second voltage compensation module, configured to: obtain a real-time feedback voltage output by the target atomization plate within a preset time range, extract a target voltage from the real-time feedback voltage, detect, by using the reference feedback voltage as a reference value, whether there is power offset of the target voltage, and if there is the power offset, trigger second power compensation of the target atomization plate, and run a water shortage detection program simultaneously;
a water shortage detection module, configured to: extract a to-be-detected time domain signal from the real-time feedback voltage and search for a characteristic value from the to-be-detected time domain signal, wherein the characteristic value consists of a rising edge and a falling edge and exists in a discrete voltage on a downward trend as a whole; and
a power-off module, configured to: when the characteristic value is detected, stop voltage input of the target atomization plate.

9. An apparatus for detecting water shortage of a humidifier, wherein the apparatus comprises a memory, a processor, and a communication module, wherein
the memory is configured to store executable program code;
the processor is coupled with the memory; and
the processor invokes the executable program code stored in the memory to perform the method for detecting water shortage of a humidifier according to claim 1.

10. A computer-readable storage medium, wherein the computer-readable storage medium stores a computer instruction, and when being invoked, the computer instruction is used to perform the method for detecting water shortage of a humidifier according to claim 1.
